(19) United States
(12) Patent Application Publication
(10) Pub. No.: US 2012/0155549 A1
(43) Pub. Date: Jun. 21, 2012

(54) Wireless Robust Modulation-Demodulation Communication Methode & Device And Rear Viewing Device For Vehicle

(76) Inventor: June-Soo Oh, Seoul (KR)

(21) Appl. No.: 12/090,312

(22) PCT Filed: Oct. 16, 2006
(86) PCT No.: PCT/KR06/04170

§ 371 Date: Apr. 15, 2008

(30) Foreign Application Priority Data
Oct. 15, 2005 (KR) 10-2005-0097273
Oct. 27, 2005 (KR) 10-2005-0101674
Oct. 16, 2006 (KR) 10-2006-0100189
Oct. 16, 2006 (KR) PCT/KR2006/004170

(51) Int. Cl. H04N 7/24

(52) U.S. Cl. 375/240.25; 375/E07.003

(57) ABSTRACT

The invention concerns a wireless communication device making use of a robust wireless communication method (RWCM), and its application on a rear view monitoring system. More specifically, a robust wireless communication device (RWCD) consists of a Data Selection part (11), a Modulation-Demodulation (M-D) part (12) and a TDMA RF Transceiver part (13) that is made up of an ISM Transceiver part (14) and an UHF Transceiver part (15). The Data Selection part (11) sorts the input data into simple or multimedia data, and sends them to the M-D part (12). The simple data are separated into two types: data that do not use multi-media or UHF wave band, and data that do use the UHF band. The M-D method for the former does not include the OOK (On/Off Keying) process which does get used for the latter. In the ISM Transceiver part (14), the non-UHF band simple data and multi-media data are communicated via ISM band or free small-power frequency range. The UHF Transceiver part (15) transmits and receives the simple data that use the UHF band.

### TECHNICAL FIELD

The invention concerns a wireless communication device making use of a robust wireless communication method (RWCM), and its application on a rear view monitoring system. More specifically, a robust wireless communication device (RWCD) consists of a Data Selection part (11), a modulation-demodulation (M-D) part (12) and a TDMA RF Transceiver part (13) which carries out ISM communication (14) and UHF communication (15). The Data Selection part (11) sorts the input data into simple or multimedia data, and sends them to the M-D part (12). The simple data are divided into two: the ones that do not use multi-media or UHF wave band, and the ones that use the UHF band. The M-D method for the former does not include the OOK (On/Off Keying) process which is not used for the latter. In the ISM Transceiver part (14), the non-UHF band simple data and multi-media data are communicated via ISM band or free small-power frequency range. The UHF Transceiver part (15) transmits and receives the simple data that use the UHF band.

### BACKGROUND ART

Current technologies in wireless communication, when transmitting multi-media data such as movie or audio clips (wireless multi-media streaming) or simple data for control, alarm or warning (two-way communication), cannot distinguish the data type if they are in analogue or digital format. In addition, it is not clearly stated which frequency band it uses, whether it is extremely low power radio or not, whether it is in uses low or high power, whether the RF amplifier is linear of non-liner, and how it will solve the issues related to malfunction by noise or interference, jamming, wiretapping or the degradation of transmission. Without the information on these issues, it has been difficult to understand how any inventions and designs would function.

In reality, many products in the market today have these issues unresolved sufficiently before the commercialization. The solutions have not been provided even after the products were put in the market, inviting complaints from customers. Some even advise customers to turn off certain functions as a solution.

### DISCLOSURE OF INVENTION

### Technical Problem

The proposed invention aims to solve the above-mentioned issues. We propose to use a “robust wireless communication method (RWCM)”, defined in the invention, between a master and a slave device and within the devices themselves. It will ensure very low error rate and a device robust to multiple access interference (MAI), enabling smooth and distortion-free wireless digital communication for simple and multi-media data. It also makes the wireless digital communication part in a master and a slave device simple, and uses less energy by adopting TDMA RF parts, lowering the cost in production.

The invention can be applied to a rear/front/side view monitoring system for vehicles, making use of the master and slave devices of the invention. In addition, we aim to provide a technical basis for future expansion of functions such as ubiquitous computing and networking, multi-media (wireless/portable internet connection, MP3 players, movie players, digital cameras, reception of Terrestrial-Digital Multimedia Broadcasting (T-DMB)/satellite DMB [Digital Multimedia Broadcasting], GPS/Navigation devices, Telematics terminals, digital camcoders, digital voice recorders, FM radio etc.), wireless security cameras, blackboxes for vehicles, auto parking, cell phones and wireless telephones.

### Technical Solution

To achieve the above-mentioned purposes, the invention consists of a Data Selection part (11), a modulation-demodulation (M-D) part (12), and a TDMA RF Transceiver part (13) which carries out ISM communication (14) and UHF communication (15). The Data Selection part (11) sorts the input data into simple or multimedia data, and sends them to the M-D part (12). The simple data are divided into two: the ones that do not use multi-media or UHF wave band, and the ones that use the UHF band. The M-D method for the former does not include the OOK (On/Off Keying) process which is not used for the latter. In the ISM Transceiver part (14), the non-UHF band simple data and multi-media data are communicated via ISM band or free small-power frequency range. The UHF Transceiver part (15) transmits and receives the simple data that use the UHF band.

It can also feature a Robust Wireless Transceiver part (10) performs the modulation/demodulation in robust wireless communication. A TDMA RF Transceiver part (20), connected to the Robust Wireless Transceiver part (10), receives and transmits the data. Other parts include a processor/control CPU part (30), a Memory part (40) that acquires and stores data needed for operation, a video Codec part (50), an audio Codec part (60), an interface for the input/output of external signals (70), a Recharging Circuit part (80) and a Displayer part (90).

In another case, it can be made up of the above mentioned parts, except the Displayer part (90). Instead it can have a main displayer (110) with a built-in Recharging Circuit part (80). A Rotating Displayer part (120) is connected to a side or the bottom of Mainbody of Displayer (110) via Rotating Joint part (150) and Rotational Axis (151). A Displayer Window part (121) is attached to the front of the Rotating Displayer part (120), and Sliding Clip Holders (140) installed at the lower and upper part of the both sides of Mainbody of Displayer (110), along with a keypad (170) that receives input for operation.

A Selective Function Optical Lens part (210) has selective functions of auto focus (AF) and pan/tilt/optical zoom, which feeds into an Image Sensing part (220). The image enhancement processing part (230) then removes noise in the signal from the Image Sensing part (220) to provide a high quality images even in low (below 0.5 LUX) and high illumination (over 20,000 LUX), and controls AF/Pan/Tilt/optical zoom functions. Also featured are a video Codec part (240), a processor/control CPU part (250), a Memory part (260), a Robust Wireless Transceiver part (270), TDMA RF Transceiver part (280), reversing light sensing circuit part (290), brake light sensing circuit part (291). The main slave device for rear view monitoring (201) has the Selective Function Optical Lens parton the front, with built-in parts such as an Selective Function Optical Lens part (210), an Image Sensing part (220), a image enhancement processing part (230), a video Codec part (240), a processor/control CPU part (250), a Memory part (260), a Robust Wireless Transceiver part (270), a TDMA RF Transceiver part (280), a reversing light sensing circuit part (290) and a brake light sensing circuit part (291).

### ADVANTAGEOUS EFFECTS

The proposed “RWCM”, when used between a master and a slave device or within the devices themselves, have the merits of a low error rate that enables a device robust to MAI (Multiple Access Interference); a smooth digital communication according to the nature of the data: simple or multi-media; a simple wireless digital communication part in a master and slave devices; an efficient use of energy by using TDMA RF parts, which all together lowers the production cost of a wireless communication system and makes various applications easy.

In addition, the invention can be easily applied to a rear/front/side view monitoring system for vehicles, making use of the master and slave devices of the invention. It can also provide a technical basis for future expansion of functions such as ubiquitous computing and networking, multi-media (wireless/portable internet connection, MP3 players, movie players, digital cameras, reception of Terrestrial-Digital Multimedia Broadcasting (T-DMB)/satellite DMB [Digital Multimedia Broadcasting], GPS/Navigation devices, Telematics terminals, digital camcoders, digital voice recorders, FM radio etc.), wireless security cameras, black boxes for vehicles, auto parking, cell phones and wireless telephones.

### BRIEF DESCRIPTION OF THE DRAWINGS

FIG. 1: Diagram of a robust wireless communication device (RWCD)

FIG. 2: Flowchart of a RWCD

FIG. 3: OOK (On/Off Keying) carrier waves of simple data in wireless transmission by a RWCD

FIG. 4: Block diagram of the master device in a RWCD

FIG. 5: The master device of a rear view monitoring system, using the robust wireless communication method (RWCM) (Skewed view from front)

FIG. 6: The RWCM-using master device of a rear view monitoring system (Skewed View from Rear)

FIG. 7: The RWCM-using master device of a rear view monitoring system, mounted on a rear view mirror (Skewed view)

FIG. 8: The RWCM-using slave device of a rear view monitoring system (Skewed View from Front)

FIG. 8a: The RWCM-using slave device of a rear view monitoring system (Side view)

FIG. 9: The master and slave device of a RWCD-using rear view monitoring system, installed on a vehicle

FIG. 10: Block diagram of the slave device of a RWCD-using rear view monitoring system

FIG. 11: Operation diagram of the master and slave device of a RWCD-using rear view monitoring system

FIG. 12: Flowchart of the signal in the master and slave device of a RWCD-using rear view monitoring system. The signal is controlled in the master device.

FIG. 13: Flowchart of the signal in the master and slave device of a RWCD-using rear view monitoring system. The signal is controlled in the slave device.

FIG. 14: The master device of a RWCD-using rear view monitoring system installed on a portable device (Skewed view from front)

FIG. 15: The master device of a RWCD-using rear view monitoring system (Skewed View from Front)

FIG. 16: The master device of a RWCD-using rear view monitoring system, installed with a displayer (Skewed view from front)

FIG. 17: The master device of a RWCD-using rear view monitoring system without a portable displayer (Skewed view from front)

<LEGENDS:>
10: Robust Wireless Transceiver part
11: Data Selection part
12: Modulation-Demodulation part
13: TDMA RF Transceiver part
14: ISM Transceiver part
15: UHF Transceiver part
16: Image Enhancement Processor part
17: Image Sensing part
18: Selective Function Optical Lens part
20: TDMA RF Transceiver part
30: Data Processing/Control CPU part
40: Memory part
50: Video Codec part
60: Audio Codec part
70: Interface part for External Signal Input/Output
80: Recharging Circuit part
90: Displayer part
100: Master Device
110: Mainbody of Displayer
120: Rotating Displayer part
121: Displayer Window part
130: Rear-view Mirror
140: Sliding Clip Holder
141: Rubber Pad
142: Screw
143: Screw Hole
160: Solar Battery
161: Auxiliary Solar Battery
170: Keypad Panel
200: Rear-view Camera/Casing Device
201: Slave Device
210: Selective Function Optical Lens part
220: Image Sensor part
230: Image Enhancement Processor
240: Video Codec part
250: Data Processing/Control CPU part
260: Memory part
270: Robust Wireless Transceiver part
280: TDMA RF Transceiver part
290: Reversing Light Sensing Circuit part
291: Brake Light Sensing Circuit part
292: Tail Light
293: Flash Lamp
600: Portable Device Contact/Joint part
601: Connector
602: Connector for External Interface
603: Screen of a Portable Devices
604: Portable Devices
605: Connector-Locking Device

### BEST MODE FOR CARRYING OUT THE INVENTION

Below we explain with figures an application of a RWCD in detail, followed by a RWCD-using rear view monitoring system and an audio/video system for vehicles.

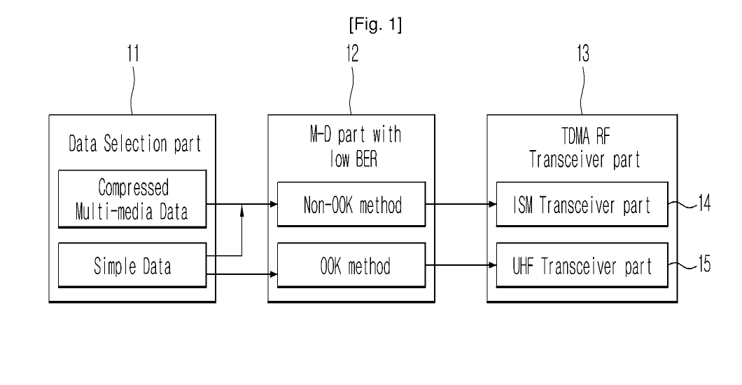

A robust wireless communication device (RWCD), as shown in FIG. 1, consists of a Data Selection part (11), a Modulation-Demodulation part (12) and a communication part (13).

In current invention, the “robust wireless communication method (RWCM)” uses in short-distance wireless communication the frequency band that has no restrictions (for example, unlicensed industrial scientific and medical (ISM) band or free small-power band) and extremely low power radio in an ultra high frequency (UHF) band selected by the regulations/restrictions of ▭▭▭ according to local areas. Even when several users simultaneously use the same frequency band (one common channel, e.g., 125 MHz in 5.725-5.850 GHz), the bit error rate (BER) of data transmission is kept within the range of 10⁻³˜10⁻¹⁰ from the intentional or unintentional multiple access interference (MAI) among users or by adjacent frequency bands. The RWCM ensures independent robustness between the initial signal and the channels assigned to users, and the form of modulated signal is labelled as digital symbols of binary bit stream that can make use of TDMA RF parts. With the RWCM, the encryption and channel coding method enables digital wireless multiplexing and access.

Therefore the “robust wireless modulation part” of this invention should use, in case of multi-media data, the ISM and unlicensed small-power frequency bands that has no restriction. For simple data that uses frequencies in a UHF band, extremely low power radio in an UHF band regulated by Wave Regulation according to local areas. Depending on the nature of the transmitted data—whether they are simple, audio, video or still images etc., a Modulation-Demodulation (M-D) method that guarantees the error rate within the range of 10⁻³˜10⁻¹⁰ should be used. The Radio Frequency (RF) parts in the last step in transmission and the first step in reception should use the TDMA RF parts that has low power consumption (below 100 mW). In particular, when using extremely low power radio in a UHF band in transmitting/receiving simple data, the “robust wireless modulation part” must include OOK (On/Off Keying) M-D method in the last step modulation method and the first step demodulation method.

The reason we use “RWCM” defined above in the invention is to guarantee the low transmission error rate in transmitting simple and multi-media data smoothly and without distortion, and the robustness to MAI. It simplifies the structure of the circuits and design of products and its low energy consumption can be achieved by using TDMA RF parts (e.g., below 100 mW and with a long operational lifetime), which overall result in a cheaper product. The transmission error rate that ensures smooth streaming service, that is to recover the initial digital signals with high fidelity, are below 10⁻³ for MPEG-4 type movies, below 10⁻⁵ or 10⁻⁴ for H.264 type data and below 10⁻⁴ for the ADPCM type audio data.

The Data Selection part (11), as shown in FIG. 1, decides whether the signal to be transmitted are simple data that use of extremely low power radio in the UHF bandwidth, or the other type of simple data or multi-media data. Then it transmits the data to the modulation-demodulation (M-D) part (12), to be explained below, via different channels depending on the data characteristics: whether the M-D process will include the OOK (On/Off Keying) or not. The technological details of the part are in public domain and thus omitted here.

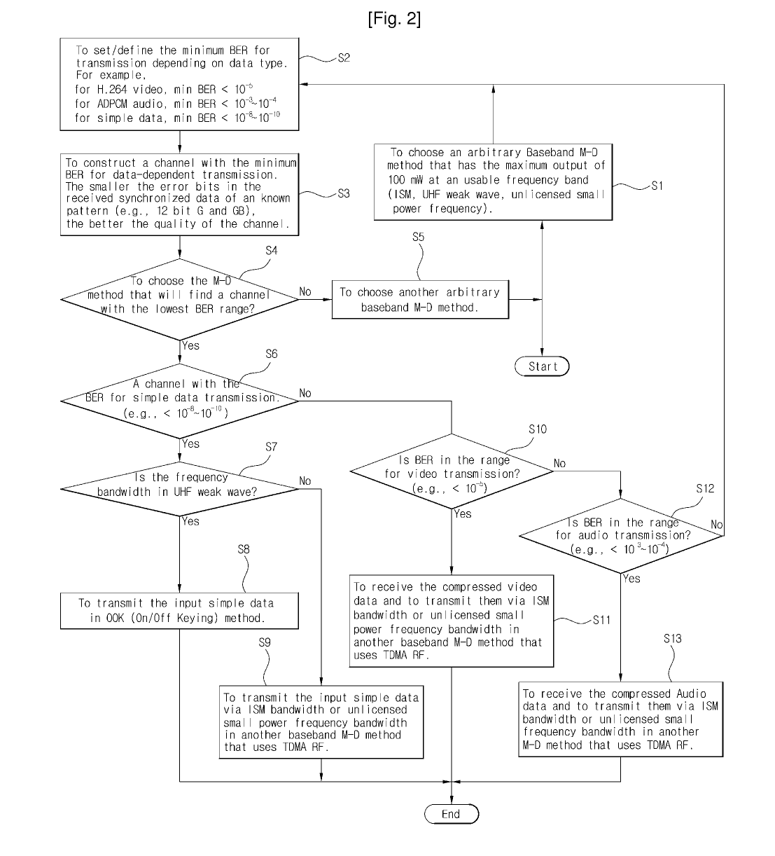

The M-D part (12) performs the OOK (On/Off Keying) M-D for the simple data that use a UHF band, and the M-D without the OOK for the rest (FIG. 2). For the former, the OOK modulation is generally used for binary data, which corresponds to AM (amplitude modulation) in analogue communication. The AM high frequency carrier signal is in TDMA RF pulses that indicate binary “1” mask and “0” space.

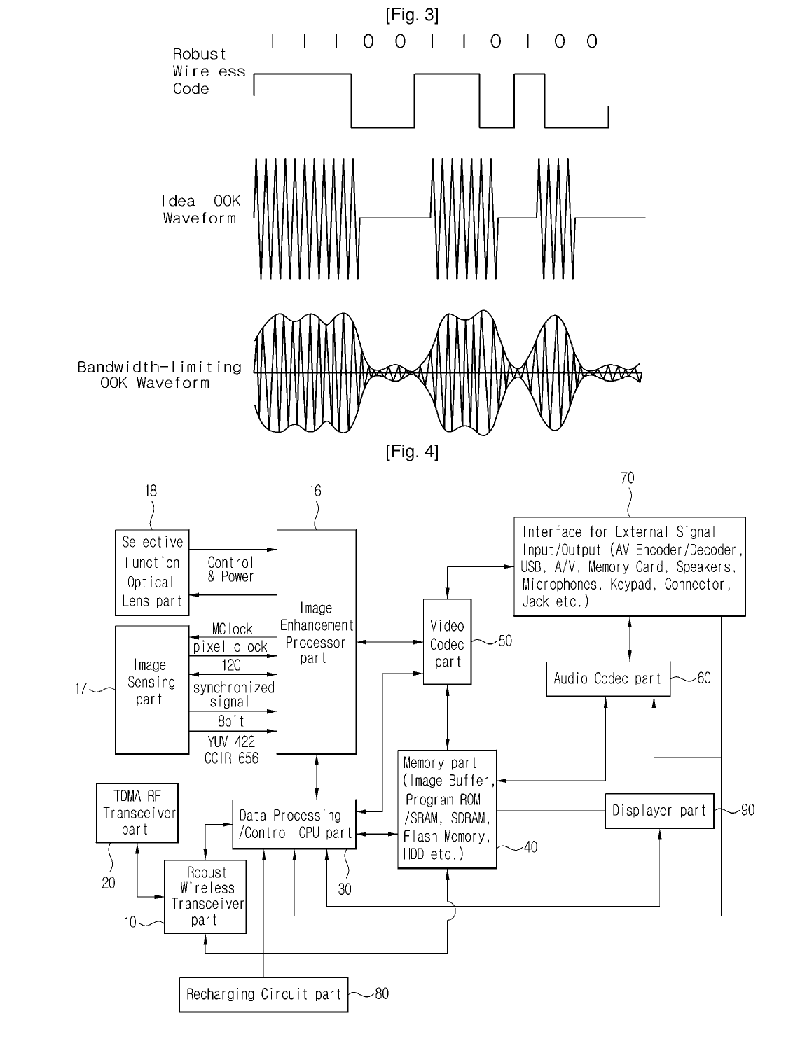

FIG. 3 presents an example of OOK carrier waves corresponding to the packet code of wirelessly transmitted of simple data using extremely low power radio in a given UHF band.

The TDMA RF Transceiver part (13) consists of a UHF (Ultra High Frequency) communication part (15) and the ISM Transceiver part (14). The former receives the simple data that use extremely low power radio in a UHF band from the M-D part (12), while the latter takes care of the rest. The simple data (binary control commands and bit stream data), transmitted via the Data Selection part (11) and the M-D part (12), are communicated via extremely low power radio of the UHF band (300 MHz-3 GHz) which suffers less jamming than the VHF bandwidth (30 MHz-300 MHz), and use the ASK (Amplitude Shift Keying) method. The UHF band has switchable frequency bands (e.g., 310 MHz, 315 MHz, 434 MHz, 868 MHz etc.) regulated by Wave Regulations according to local areas. The power output of extremely low power radio is desirable to be within the regulations and restrictions of Wave Regulations: for example, the intensity of the electromagnetic field should be measured below 500 μV/m at a 3 m distance when using a frequency below 322 MHz. In case of the multi-media data (e.g., the image monitoring of an outdoor parking lot and short-distance wireless communication, audio/video streaming etc.), the unlicensed (free) bandwidth is used in lower power (below 100 mW) for wireless short-range communication: e.g., ISM band, a 528 MHz bandwidth in 3168-4752 MHz band, 2 or 4.8 GHz bandwidth in the 3.1-4.9 GHz and 6.2-9.7 GHz, 2.3 GHz, 2.4 GHz, 5 GHz, bands. The invention advises to use the Robust Wireless Transmission which ensures good quality transmission free from interferences. It applies the TDMA RF method (GFSK, BPSK, QPSK, DBPSK) to the transmission data code, making it strong in the time-variant wireless environment and multi-media data can be transferred without traffic.

The master device for robust wireless communication (100) (FIG. 4) has a Robust Wireless Transceiver part (10), to which a TDMA RF Transceiver part (20) is connected. The latter transmits and receives data to the air. It also features a processor/control CPU part (30), a Memory part (40) that acquires and restores the data for operation, a video Codec part (50), an audio Codec part (60), an interface for the input/output of external signal (70), a Recharging Circuit part (80) and a display part (90).

The Robust Wireless Transceiver part (10) performs the aforementioned robust M-D process. That is, the part decides and classifies if the input data are simple or multi-media data and performs a M-D process accordingly.

The TDMA RF Transceiver part (20) communicates data either in the UHF communication for the simple data that use extremely low power radio in a UHF band, or in the ISM communication for the non-UHF using simple data and multi-media data.

The processor/control CPU part (30) controls the Robust Wireless Transceiver part (10), the TDMA RF Transceiver part (20), a Memory part (40), a video Codec part (50), an audio Codec part (60) and an input/output interface for external signals (70).

The Memory part (40) for image buffers and program data, such as ROM/RAM/SDRAM, SRAM, Flash memory, HDD etc., restores the operational information or operation programs necessary for the master device of a RWCM (100) to function. It also restores the input and output of audio-visual signals as well as general data.

The video Codec part (50) compresses the video data among multi-media data using a certain compression format (e.g., H.264, MPEG-4, etc.) to reduce the size in transmission, and decompresses the received data back to the original form. The audio Codec part (60) compresses the audio data among multi-media data using a certain format (e.g., ADPCM, MP3, WMA, AAC etc) to reduce the size, and decompresses the received data back to the original form.

The Interface part for External Signal Input/Output (70) such as A/V Encoder/Decoder, USB, A/V, memory cards, speakers, microphones, keypads, connectors, JACK etc., receives external input via keypads, or controls the input/output of external video or audio data, or sends and receives data to and from external devices.

Recharging Circuit part (80) provides electric power to operate the master device for robust wireless communication (100). It consists of recharging batteries and recharging circuits, and should be rechargeable using various power sources at homes, vehicles or from solar batteries.

Displayer part (90) displays the image signal from the Memory part (40) of the RWCD Master Device (100), or operation-related information (e.g., function selection, operational status, warning signs etc.).

In the mean time, the above-mentioned Master Device (100) is desirable to include an Selective Function Optical Lens part (18), an Image Sensing part (17) and an Image Enhancement Processor (16). Here the signal interface between the Image Sensing part (17) and the Image Enhancement Processor (16) needs to be VGA or better than mega pixels. The video data from the Image Sensing part (17) is 8-bit YUV422 or CCIR-656/601. The Mclock to operate the Image Sensing part (17) is the internal Register controlling I2C communication signal. The pixel clock is synchronized with video data. There are synchoronizing signals to distinguish frame by frame and line by line. In addition, the master device (100) can be previewed on Displayer part (90) at Full Frame Rate (e.g., 30 fps) after passing through the Image Enhancement Processor (16). The input image compressed by the video Codec part (50) can be restored in the Memory part (image buffer) (40), and then the compressed image data in the image buffer (40) can be displayed on Displayer Window part (121) via Displayer part (90). FIG. 6 shows a Selective Function Optical Lens part (18), an Image Sensing part (17) and an Image Enhancement Processor (16) embedded in the Master Device (100). The Indoor Camera (152) is desirable to be rotatable 180 degrees back and forth, and to have the capacity to feed video data to the Data Processor/Control CPU part (30) and the Memory part (40) via the Interface for External Signal Input/Output (70) (e.g., USB2.0 host/slave method, Local BUS method etc.).

An Application: A RWCD-Using Rear View Monitoring System

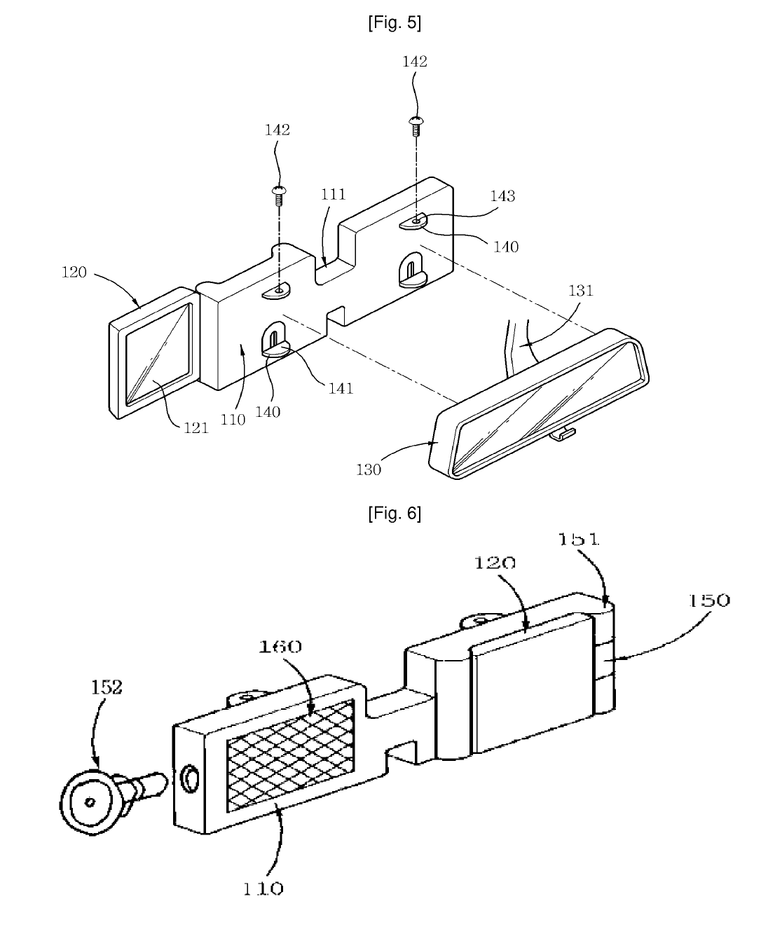

FIG. 5 shows the RWCD-using master device of a rear view monitoring system for vehicles consists of Mainbody of Displayer (110). It consists of a Robust Wireless Transceiver part (10) that communicates via the RWCM, to which a TDMA RF Transceiver part (20) is attached to transmit/receive the date to the air. The master device also include a processor/control CPU part (30), the Memory part (40) to acquire and restore operational data, a vide Codec part (50), an audio Codec part (60), input/output interface for external signals (70) and a Recharging Circuit part (80). It is desirable to include a Selective Function Optical Lens part (18), an Image Sensing part (17) and an Image Enhancement Processor (16) which can be included in the main displayer (110) as a built-in or separately as shown in FIG. 6.

In particular the rear view monitoring system in this invention consists of Rotating Displayer part (120) attached to one side, or bottom or top side of the Mainbody of Displayer (110) with the Rotating Joint part (150) and the Rotational Axis (151), and Displayer Window part (121) installed on the front of Rotating Displayer part (120). It also consists of the Sliding Clip Holders (140) on both sides on the front of the Mainbody of Displayer (110), the Keypad Panel (170) that receives the input through keys, and the Portable Device Contact/Joint part (600) which is another form of Rotating Joint part (150), the Rotating Displayer part (120) or on one side of the Mainbody of Displayer (110) (FIGS. 5 & 6).

First of all, it consists of the same components as in the RWCD master device (100): a Robust Wireless Transceiver part (10), a TDMA RF Transceiver part (20), a processor/control CPU part (30), a Memory part (40), a video Codec part (50), an audio Codec part (60), an input/output interface for external signals (70) and a Recharging Circuit part (80).

Within the Mainbody of Displayer (110) are the aforementioned Robust Wireless Transceiver part (10), the TDMA RF Transceiver part (20), the processor/control CPU part (30), the Memory part (40), the video Codec part (50), the audio Codec part (60), the input/output interface for external signals (70) and the Recharging Circuit part (80). In addition, as shown in FIG. 6, the Selective Function Optical Lens part (11), the Image Sensing part (12) and the Image Enhancement part (13) are controlled by the Master Device (100) and connected to the Mainbody of Displayer (110). A separate Indoor Camera (152) that can rotate 180 degrees back and forth, transmits video data the Data Processor/Control CPU part (30) and the Memory part (40) via the Interface for External Signal Input/Output (70) (e.g., USB2.0 host/slave method, Local BUS method etc.).

When installing the main displayer (110), it is desirable to have hollowed out in the middle to avoid blockage by the Rear-view Mirror Support (131) as shown in FIG. 5.

The Rotating Displayer part (120) in FIG. 6 will be installed on a side or bottom or top part of the Mainbody of Displayer (110) via Rotating Joint part (150) and the Rotational Axis (151). On the front of the Rotating Displayer part (120), a Displayer Window part (121) will be attached to display images, still shots or operational status from the rear view camera.

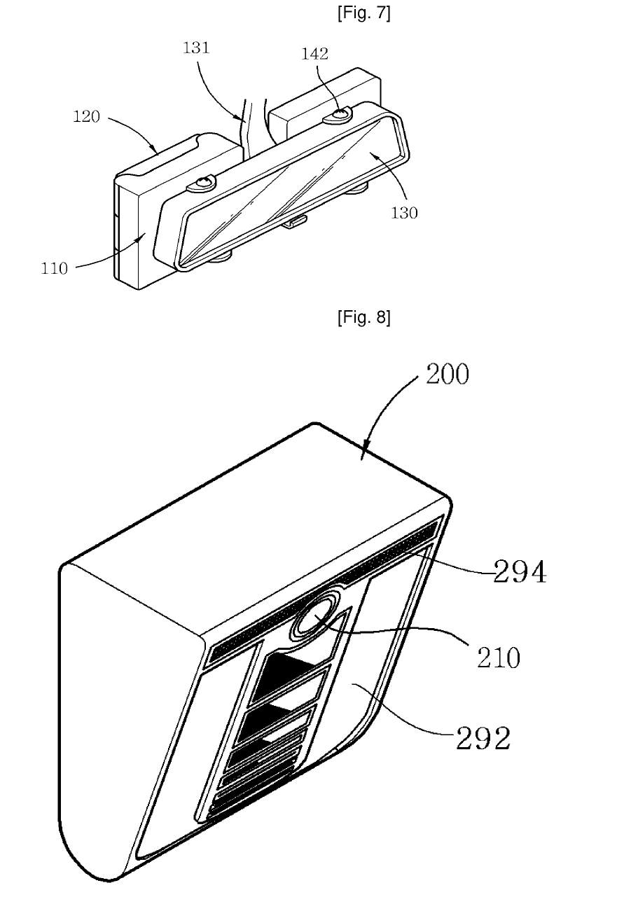

FIG. 5 shows Sliding Clip Holders (140) which are installed on the top and bottom parts on the both sides of Mainbody of Displayer (110). The top or bottom two Sliding Clip Holders (140), as shown in FIG. 7, will tightly secure Mainbody of Displayer (110) at the back of the Rear-view Mirror (130) by the elastically returning force. In this case, a Rubber Pad (141) will be inserted on the part Sliding Clip Holders (140) contacts a Rear-view Mirror (130), which will increase the friction (FIG. 5) and shock absorption from a running vehicle to fasten the Mainbody of Displayer (110) to the Rear-view Mirror (130). In the mean time, it is desirable to form a Screw Hole (143) to the Sliding Clip Holders (140) (FIG. 5) and to have a Screw (142) inserted in the Screw Hole (143) to secure the Rear-view Mirror (130) further to the Mainbody of Displayer (110).

Rotating Joint part (150) will be attached to a side or the backside of the Mainbody of Displayer (110) (FIG. 6). Combined with the Rotational Axis (151), it enables for the Rotating Displayer part (120) to rotate around the Mainbody of Displayer (110). The driver of a vehicle can adjust the Rotating Displayer part (120) at a proper angle depending on his or her size or driving position. Even when the RWCD master device (100) is not used, the Rotating Displayer part (120) can be enclosed in the backside of Mainbody of Displayer (110) for protection as depicted in FIG. 6.

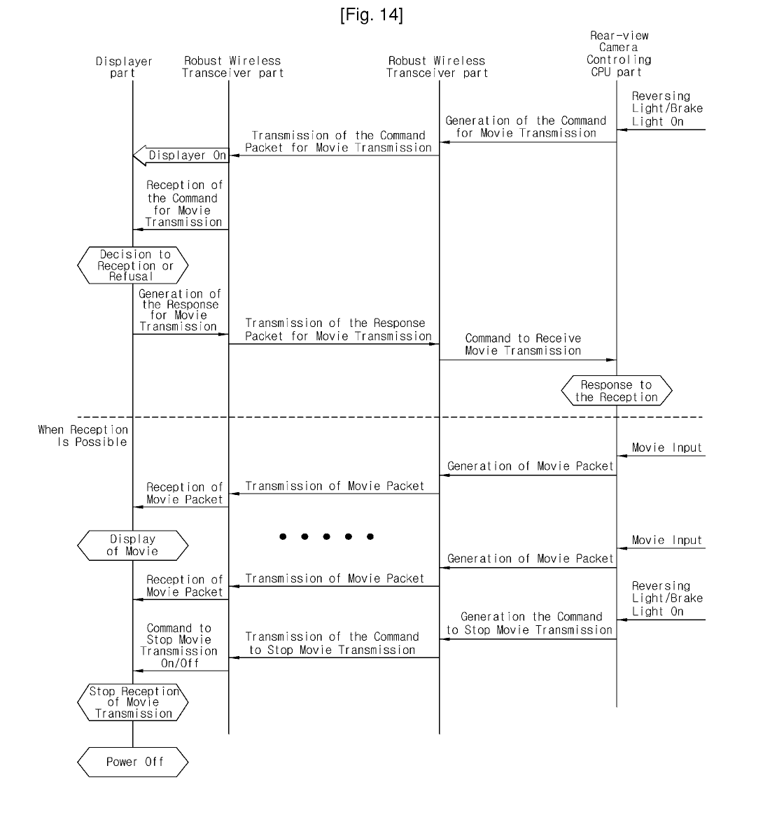

Following is another form of Rotating Joint part (150) and Rotational Axis (151) (FIG. 14). It is equipped, on a Portable Device Contact/Joint part (600), with a (male) connector (601) and a clamp part Connector-Locking Device (605) which can be connected to the External Interface (female) connector (602) to a Portable Device (604) such as cell phones, PMP, MP3P, DMB, navigation devices, digital cameras and camcoders etc. Take an example of a cell phone which uses a Connector (601) of a 24-pin KTTA (Korean Telecommunication Technology Association) standard. The (male) interface connector (601) can be located in a position that can be joined with a female connector (602) of the cell phone at the Portable Device Contact/Joint part (600) to which a Connector-Locking Device (605) is attached to the both sides of one side. Out of the KTTA starndard interface 24-pins, the pins that are used in USB communication and recharging the cell phone battery (for example, pin #1 (BATTERY ID), #10▭ (USB D−), #12 (GND POWER), #15 (USB D+), #16 (USB Vbus), #19 (GND POWER), #21 (BTT+) and #22▭ (BTT+)) can be selectively extracted to meet the corresponding pins of the male connector (601). It enables the USB communication with the USB slave (or host) of the cell phone, via the Memory part (40) and the USB host (or slave) part (figure not presented) of the processor/control CPU part (30) in the master device for vehicles. The decompressed digital image data (e.g., YUV signals) recovered at the video Codec part (50) of the Robust Wireless Transceiver part (10), then can be sent to the cell phone. The automatic recognition function of the USB communication then activates the image viewer program (figure not presented) built-in the Memory part (40) of the cell phone, and the Graphic Controller (figure not presented) of the phone displays on the Screen of a Portable Device (603) of a cell phone (604) the digital images of the rear view monitoring camera.

Therefore by fastening Portable Device (604) to Portable Device Contact/Joint part (600) of the vehicle master device by Connector-Locking Device (605), the Portable Device battery (606) can be recharged by the solar batteries (160, 161). At the same time, the automatic recognition function of the USB host and salve will display the image taken by the rear view monitoring camera on the screen of a cell phone (603). It is worth additional mentioning that what recharges the battery of Portable Device is the Recharging Circuit part (80) of Portable Device within the master device for vehicles. When the (digital) MICOM (micro-controller) method rather than an analogy counterpart, a more accurate recharging can be achieved.

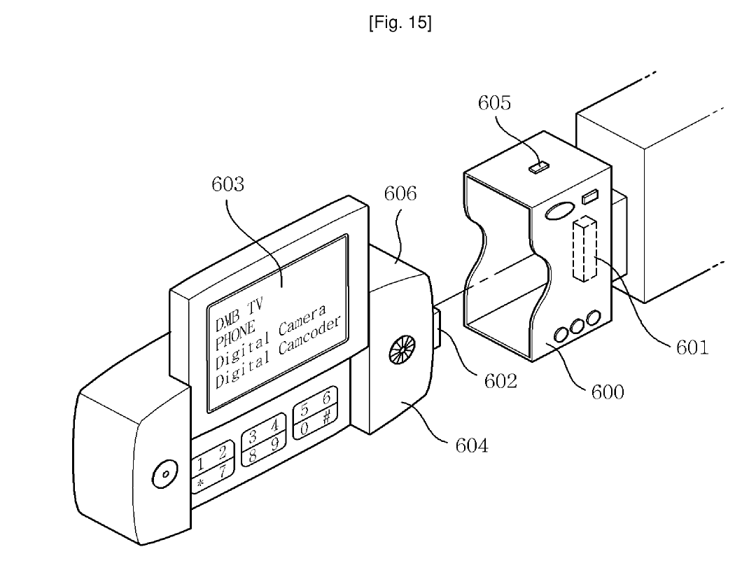

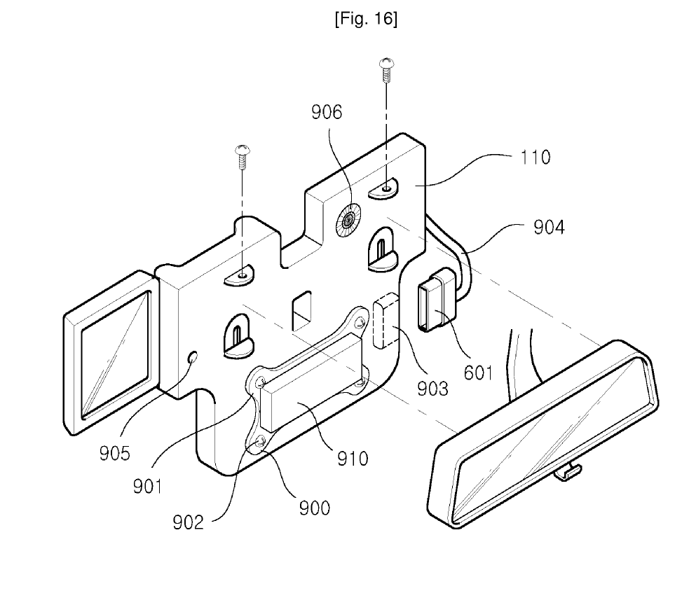

Another application of the invention is shown in FIGS. 15 and 16. It is possible to have a different configuration of Connector-Locking Device (605) of Portable Device (604) at the bottom of the Mainbody of Displayer (110). The Contact/Joint part (605) of Portable Device can be the battery Contact/Joint part (910) (the “battery replacement shape” from now on), which can directly replace the battery of Portable Device (604) as shown in FIG. 15. Or it can be cradle-shaped Contact/Joint part (911) (the “cradle structure” from now on) that can act as a cradle for Portable Device (604) as shown in FIG. 16.

FIG. 15 shows the battery replacement shape. In various Portable Devices (604), batteries are generally attached from behind. To accommodate as many terminals as possible, an extra area (901) is secured around the battery Contact/Joint part (910) and equipped with Screws (900) and Screw Holes (902) to be connected to the Mainbody of Displayer (110). When the battery is shaped to attach various Portable Devices to the Mainbody of Displayer (110), the Connector-Locking Device (605) can be replaced with the battery of the Portable Device that has a different (matching) shape. The Contact/Joint part for batteries (910) of the Portable Device (604) can be then fastened to the Mainbody of Displayer (110) with the screws (900).

FIG. 16 shows the Connector-Locking Device with cradle structure (911) which has the same function as the Connector-Locking Device (605) and comes in matching pairs to meet various shapes of Portable Device (604). It is structured in a way it can be attached and detached according to on the Surface (950) of the Portable Device (604) (e.g., attaching and detaching by sliding or insertion).

When the Portable Device (604) is fitted to the Cradle-type Contact/Joint part (911), the power is supplied via the Connector for External Interface (602) from the solar battery (160) in the Mainbody of Displayer (110) which is also equipped with the separate connecting cables (904) and connectors (601) for communication.

When Portable Device (604) is not fitted to Cradle-type Contact/Joint part (911) or not used in the cradle structure, it is desirable to have an Insert Pocket for Connector (903) to protect the connector (601).

When the Portable Device (604) is fitted to Cradle-type Contact/Joint part (911) and the driver is on the move, it is advised to equip with a microphone (905) and a speaker (906) in the Mainbody of Displayer (110) for hands-free operation via Cables (904) and the connector (601).

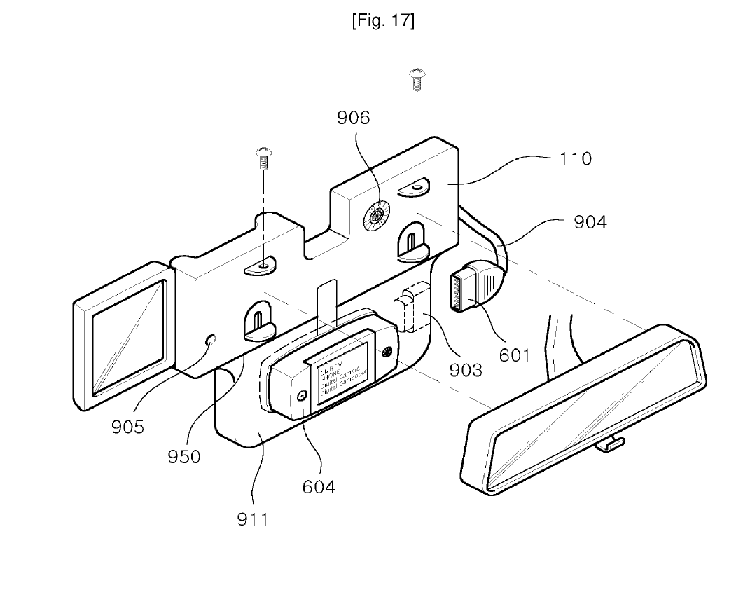

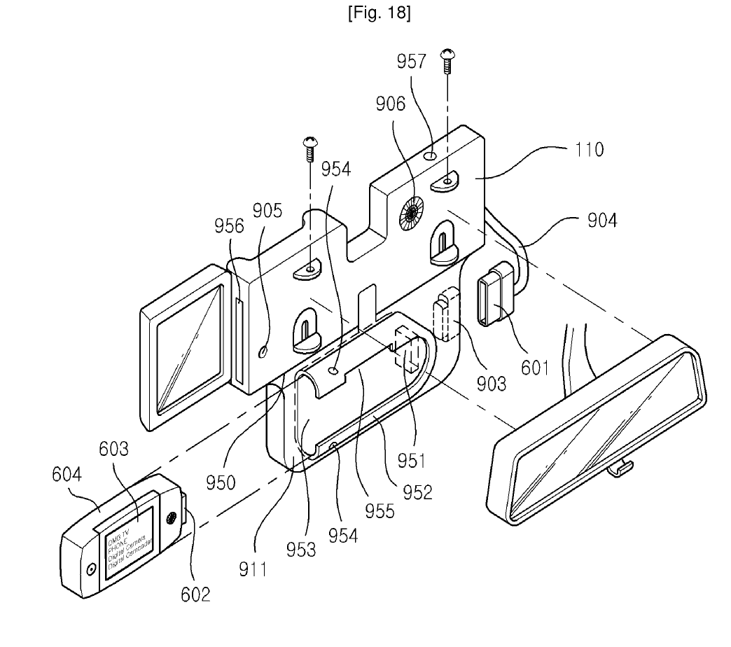

The cradle structure of the invention can be modified in various shapes. In the basic structure, it is desirable for the Portable Device (604) to be fitted to the cradle-shaped Contact/Joint part (911) and for the Connector for the cables (601) to be connected with Connector for External Interface (602) (FIG. 17). To acquire this end, the Insertion part (953) of Cradle-type Contact/Joint part (911) to which the Portable Device (604) will be inserted, is designed to accommodate it. When the Portable Device is connected to the cradle structure, the Cradle-type Contact/Joint part (911) has the open structure on the top so that the Screen of a Portable Device (603) can be seen to drivers. It also has Locking Device (954) to hold a Portable Device (604). On the side of the Connector of a connecting cable (601), it is desirable to have a blocked shape except the Passage Space (951) through which the Connector (601) of the Connecting Cable (904) and the Connector for External Interface (602) of the Portable Device (604) will get connected.

In case of a Portable Device (604) with the Screen (603) moving sideways (FIG. 17), it is good to have a Groove part (955) at the bottom or top part of the Cradle-type Contact/Joint part (911) so that it will not block the view of the Portable Device (603). In addition, the Connecting Cables (904) and Connector (901) of the Mainbody of Displayer (110) can communicate with a Portable Device (604) via the Connector for External Interface (602). It is desirable to have an external GPS Antenna Port (957) on a side of Mainbody of Displayer (110), and a Memory Card Slot (956) for a Memory Card (SD, MMC, CF or PCMCIA) that contains navigation maps and softwares or general data.

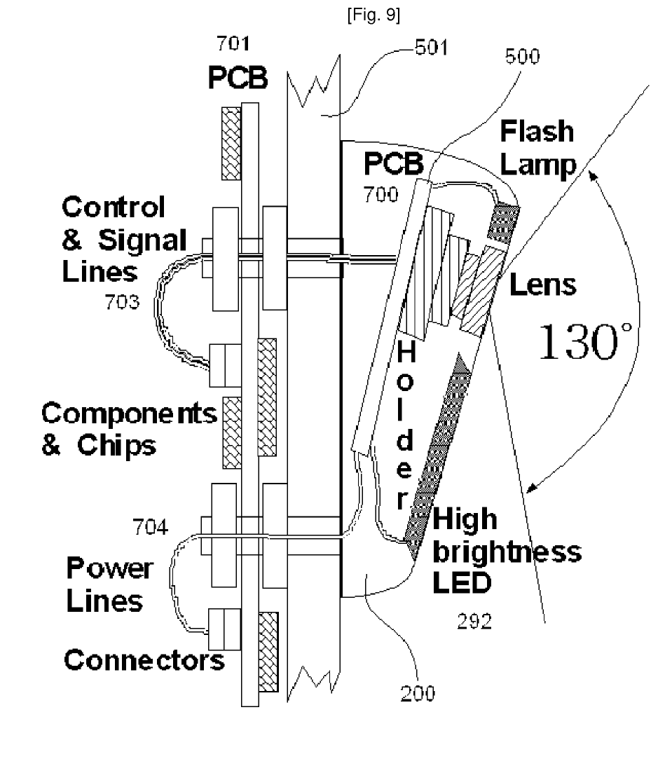

The solar battery (160) will be attached to the rear side of the Mainbody of Displayer (110) (FIG. 6), and supplies the power required for the operation of the master device and recharging the rechargeable batteries. When the solar battery (160) alone cannot supply enough power, an auxiliary solar battery (161) can be installed which will be connected to the Recharging Circuit part (80) as depicted in FIG. 9. It can be easily attached and detached on the top part of the front mirror or dashboard of the vehicle.

FIG. 11 shows the Keypad Panel (170) [put on a side of a Portable Device Contact/Joint part (600) which is another form of the Rotating Joint part (150), Rotating Displayer part (120) or Mainbody of Displayer (110), or in a detachable form] through which the following tasks that controls the master device of the rear view monitoring system are performed: power ON/OFF, commands for movie and still-image transmission, blinking of tail lights and flash lamps, camera selection (internal/external/both). The Keypad Panel can be attached to the Rotating Joint part (150), Rotating Displayer part (120) or Mainbody of Displayer (110), or can be designed as a separate panel that can be installed on the dashboard or the steering wheel of a vehicle. For the latter, it is desirable that the robust wireless method is used in control signals.

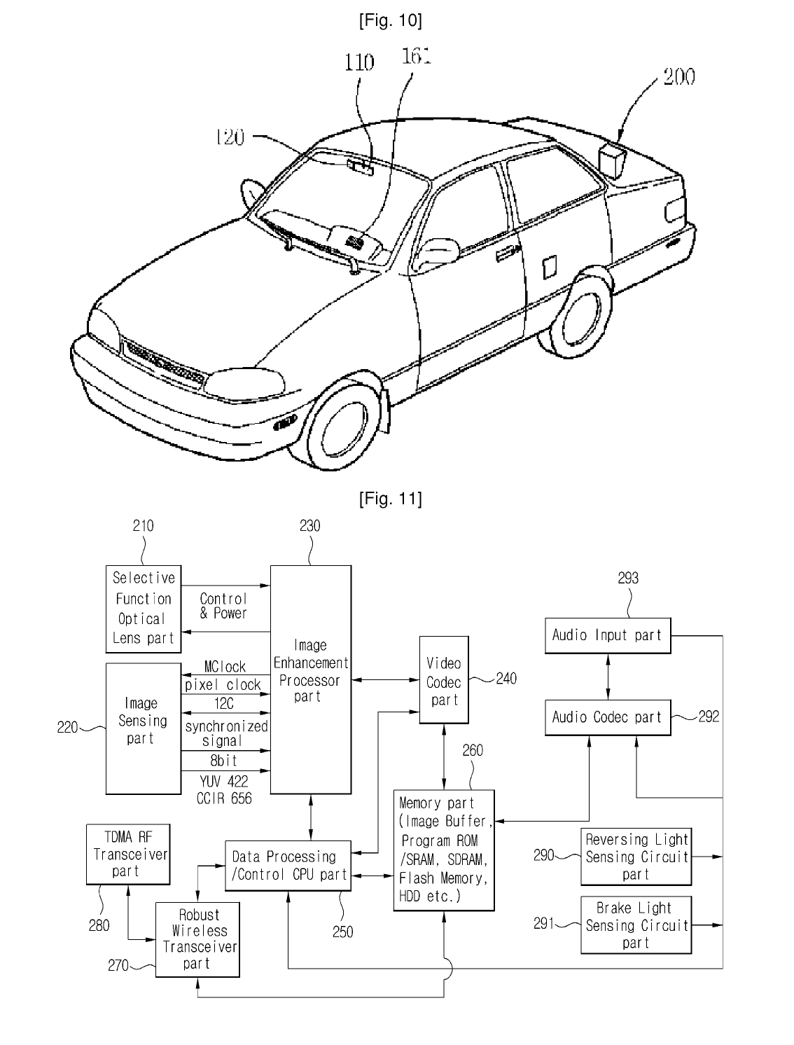

The RWCD-using slave device of a rear view monitoring system (200) (FIG. 10) consists of a Selective Function Optical Lens part (210) that has selective functions of auto focus (AF) and pan/tilt/optical zoom, which feeds into an Image Sensing part (220). The image enhancement processing part (230) then removes noise in the signal from the Image Sensing part (220) to provide a high quality images even in low (below 0.5 LUX) and high illumination (over 20,000 LUX), and controls the AF/Pan/Tilt/optical zoom functions. It also features a video Codec part (240), a processor/control CPU part (250), a Memory part (260), a Robust Wireless Transceiver part (270), TDMA RF Transceiver part (280), reversing light sensing circuit part (290), brake light sensing circuit part (291), which are all installed on the front along with the Selective Function Optical Lens part (210). In addition, it also includes the main body of the slave device (201) which encloses within its body a Selective Function Optical Lens part (210), an Image Sensing part (220), an Image Enhancement Processor (230), a video Codec part (240), a processor/control CPU part (250), a Memory part (260), a Robust Wireless Transceiver part (270), a TDMA RF Transceiver part (280), a reversing light sensing circuit part (290) and a brake light sensing circuit part (291). The slave device (200) has, as basic components, a processor/control CPU part (250), a Memory part (260), a Robust Wireless Transceiver part (270) and a TDMA RF Transceiver part (280). If needed, one or more of the following parts can be added: an optical lens part (210), an Image Sensing part (220), an Image Enhancement Processor (230), an video Codec part (240), a reversing light sensing circuit part (290) or brake light sensing circuit part (291).

The main body of the slave device (201) will have an Selective Function Optical Lens part (210) on the front, and encloses within its body an Image Sensing part (220), an Image Enhancement Processor (230), a video Codec part (240), a processor/control CPU part (250), Memory part (260), Robust Wireless Transceiver part (270), TDMA RF Transceiver part (280), audio Codec part (240), audio input part (293), reversing light sensing circuit part (290) and a brake light sensing circuit part (291). Some functions of the slave (201) can be used independently in a module. For example, the Selective Function Optical Lens part or an Image Sensing part can form a rear view module (500) and installed on the chassis of a vehicle, particularly on the location of a car emblem inside of a rear-view camera/casing device (200).

As FIGS. 8 and 8a suggest it is advised to have the rear-view camera/casing device (200) installed at the location of the emblem in a shape that can replace it. It is also advised to install the Tail Lights (292) on the face of the Rear-view Camera/Casing Device (200) to attract people's attention when the vehicle is reversing or braking. In such a case, the Tail Lights (292) can shed strong light without consuming much power, like a high-illumination LCD, and with durability and longevity. It is also advised to install a flash lamp (294) in front of the Rear-view Camera/Casing device (200) to help taking images in a dark place.

FIG. 8a shows the rear-view camera casing device (200) with the Selective Function Optical Lens part (18) installed on the circle at the top middle part (making a “i” shape), and a flash lamp (294) on the square above the “T” shape of the casing. On the U-shaped part of the casing (that excludes the circle and square), a high-il-lumination LED (e.g., in blue) (292) can be installed to alert the drivers behind the vehicle in case of braking or reversing. The “i” shape is designed with squares of increasing sizes from bottom to top to symbolize soaring, rising, growth, hope or success.

The Selective Function Optical Lens part (18) can have a wide viewing angle (for example, 100˜150 degrees). The Image Sensing part (220) right below the lens part (18) is built-in on the sensor PCB (700), and the Image Enhancement Processor (230) can be built-in the circuit on the wireless PCB (701) or the sensor PCB (700). The video Codec part (240), the processor/control CPU part (250), the Memory part (260), the Robust Wireless Transceiver part (270) and the TDMA RF Transceiver part (280) can be built-in the circuit on the wireless PCB (701).

A special feature of the invention is that usually there are two holes on a vehicle to secure the car emblem. The invention uses one of the holes (703) to connect a wireless PCB (701) to a sensor PCB (700) along with the control and signal wires. Through the other hole, the power cable is connected from the wireless PCB (701) to the sensor PCB (700), and to a flash lamp (294) and a high-illumination LED (292).

The Selective Function Optical Lens part (210) can be installed on the front of a Rear-view Camera/Casing Device (200) that is subordinate to the main body of the slave device (201) (FIGS. 8 and 8a). It has selective functions of auto focus (AF) and pan/tilt/optical zoom to optimize the condition to take images or movies.

The Image Sensing part (220) senses optical images fed by the Selective Function Optical Lens part (210).

The image enhancement processor (230) removes the noise in the signal from the Image Sensing part (220) to provide a high quality images even in low (below 0.5 LUX) and high illumination (over 20,000 LUX), and controls the AF/Pan/Tilt/optical zoom functions.

The video Codec part (240) compresses video data transmitted from the Image Enhancement Processor (230) in a certain compression format (H.264, MPEG-4 etc), or recovers the compressed data.

The processor/control CPU part (250) controls the Selective Function Optical Lens part (210), the Image Enhancement Processor (230), the video Codec part (240), the audio Codec part (240), the audio input part (293) and a Memory part (260) that will be explained below.

The Memory part (260) provides a temporary storage space when images are compressed or decompressed in the video Codec part (240). It also stores the operational programs or data for the processor/control CPU part.

The Robust Wireless Transceiver part (270) performs the robust modulation-demodulation as explained above. It determines the nature of the data, whether they are simple data or multi-media data, and carries out the M-D process accordingly.

The TDMA RF Transceiver part (280), as explained before, receives the signal from the Robust Wireless Transceiver part (270), and communicates it either a UHF communication for the simple data that use a UHF band or a ISM communication for the non-UHF band simple data and multi-media data.

The reversing light sensing circuit part (290) and brake light sensing circuit part (291) sense reversing and braking, respectively, and deliver the information to the processor/control CPU part (250).

An Application: A Robust Wireless Communication Device

The flow-chart in FIG. 2 shows how a robust communication method works, which will be explained in this section. Firstly, an arbitrary Baseband M-D method is searched for and chosen that can use the TDMA RF or a wireless Koinonia method that can have a maximum output of 100 mW (20 dBm) at a usuable frequency band: ISM, UHF weak wave, unlicensed small power frequency. (S1)

Next, the minimum BER for the data is defined as follows to select the optical BER for data transmission, either simple or multi-media, among the known or unpublished (non-standard) Baseband M-D methods. (S2)

for H.264 video, min BER <10⁻⁵

for ADPCM audio, min BER <10⁻³˜10⁻⁴

for simple data, min BER <10⁻⁸˜10⁻¹⁰

Next, channels are constructed using a known (or unpublished) Baseband M-D method. For each channel constructed, the minimum BER is measured to test the efficiency of the channel for different data to be transmitted. For example, a communication device is tested for a known pattern (for example, 128 bit G and GB) and the smaller the number of error bits for the given pattern is the better the quality of the channel (S3).

A Baseband M-D method will be chosen if it has the lowest BER values for each data type (S4). If not, another Baseband M-D method will be chosen for test and the processes (S1) to (S4) in FIG. 2 will be repeated (S5). Data will be transmitted, depending on their types, via different channels that are determined to be optimum by the above procedure (S6, S10 & S12). The UHF-band using simple data (S7) would be modulated using the OOK M-D method (S8) in the M-D part (12), and transmitted via the UHF Transceiver part (15) of the TDMA RF Transceiver part (13).

For the non-UHF-band using simple data (S9) or video (S11) or audio (S13) data, they will get compressed to reduce the data size in the M-D part (12), modulated using non-OOK method (On/Off Keying) and transmitted via the ISM Transceiver part (13) of the Transceiver part (13).

Here the wireless Koinonia method exploits the merits of pre-existing CDMA and TDMA technologies. It is, like the CDMA method, strong to internal noises and can adjust the band width in the parts of code, enabling the delicate and flexible distribution of resources. A high-speed and low-power transmission like TDMA is available, various variable transmission speed (6, 12, 22, 33, 44 & 55 Mbps) are provided. In addition, the data (both video and audio) can be transmitted without a station to a maximum distance of 500 meters. It can be transmitted while moving (80 km/h) within a short distance of 100 meters. It is a powerful ad hoc networking technology that can be used along side with the existing communication systems (WLAN, Bluetooth and Zigbee, for example) without interference. The technology guarantees high quality multi-media (QoS), and reliable data transmission by encoding the transmitted data.

On the receiving end, the ISM Transceiver part (14) takes in the non-UHF band weak wave simple data and multi-media data. The simple data using non-UHF-band weak wave will be received at the UHF Transceiver part (15), making redundant of a separate data selection process. The received data go through the above-mentioned process in reverse order: the UHF-band weak wave using simple data will be recovered in the Transceiver part (13) while those received at the UHF-band Transceiver (15) will be recovered to the simple data via the OOK demodulation process at the M-D part (12). The former will get received by the ISM Transceiver part (14) within the Transceiver part (13), and thus a separate data selection process is unnecessary. The M-D part (12) performs the non-OOK demodulation and the data return to their original simple and multi-media data by decompressing.

In the following, a master and a slave device that use the robust modulation communication device will be presented as an example.

The rear-view monitoring Master device (100) will be installed on a Rear-view Mirror (130), and the slave device (200) on the rear of a vehicle.

The slave device (200) receives, and corresponds to, the signal from the master device (100) input via keys in the Keypad Panel (170) for video transmission and the status of tail lights (high-illumination LED), flash lamps, reversing lights or break lights. An external (rear-view) camera can be selected alone or along with an internal video camera (movie or still images), in which case the images will be displayed side by side.

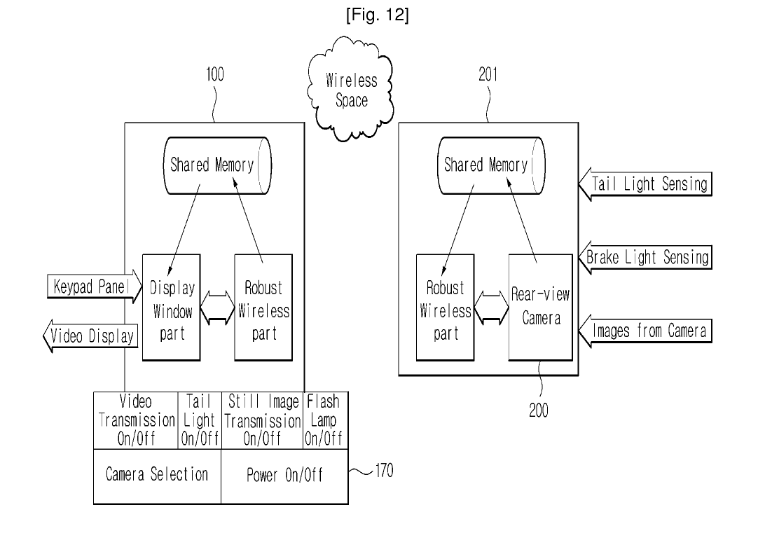

When the transmission of video (movie or still images) is requested by the master device (100) (Demand 1), it follows the procedure depicted in FIG. 12.

The processor/control CPU part (250) is demanded from the master device via the Robust Wireless Transceiver part (270) to receive a movie or still images (i.e. the Movie/Still Image is pressed ON on the keypad of the master device), it transmits to the master device (100) the images (compressed and stored in buffer memory) that, under its control, go through the Selective Function Optical Lens part (210), the Image Sensing part (220), the Image Enhancement Processor (230), the Video Codec part (240), the Memory part (260), Robust Wireless Transceiver part (270) and the TDMA RF Transceiver part (280). The movie will get transmitted constantly until the Master Device (100) commands it to stop (Movie/Still Image OFF) while the still images will get transmitted frame by frame after they are taken at a certain interval (e.g., 0.1 second). The Flash Lamp (294) can be used On/Off for taking still shots following the demand from the Master Device (100).

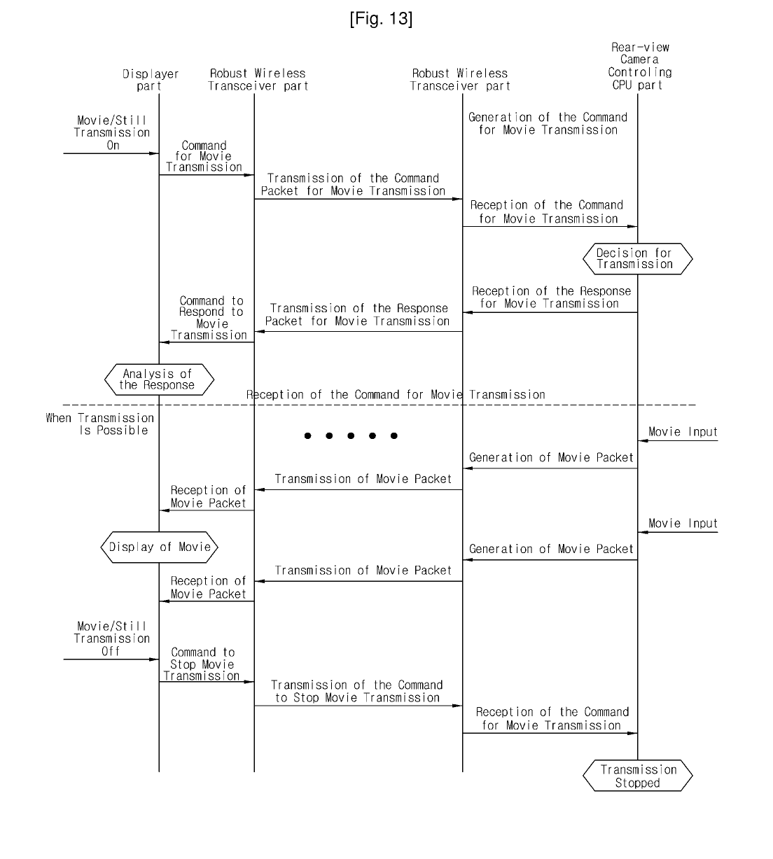

When the power supply to the Tail Lights is commanded (Demand 2), the procedure follows as shown in FIG. 13.

When the power is supplied to the Tail Lights and detected by the Reversing Light Sensing Circuit part (290), the Master Device (100) is immediately asked to go into the movie reception mode. At the same time, the Tail Lights (high-illumination LED) (292) is operated until the power is cut, and the movie is taken to be transmitted to the Master Device (100).

When the power is supplied to the Break Lights and detected by the Brake Light Sensing Circuit part (291), the Master Device (100) is immediately asked to go into the movie reception mode. At the same time, the Tail Lights (292) is turned on until the power supply is cut, and the movie that has been will be transmitted to the Master Device (100).

When the two signals (for both Brake and Tail Lights) are simultaneously received, the power supply to the Tail Lights gets the priority. More specifically, the operation of the reverse gear by a driver turns on the power supply to the Reversing Light. The circuit is constructed in a way (e.g., the voltage of the input signal to a port in the Data Processor/Control CPU part) hat, when the power supply is on, a certain amount of voltage (e.g., 12 VDC) is recognized as a signal to start movie taking. Thus the camera starts to operate when the power to the Reversing Lights are authorized, and the movie, after being taken, will be immediately transmitted to the Master Device by the RWCM.

The Master Device (100) regularly (e.g., every 0.3 second) monitors the signal from the Slave Device (200) for the command to take a movie. When such a command is detected, it immediately goes into the reception mode for the image data from the Slave Device (200). The Processor/Control CPU part (30) controls the image data that and goes through the TDMA RF Transceiver part (20), the Robust Wireless Transceiver part (10), the Memory part (40), the video Codec part (50) and the Memory part (40), and displays the recovered data at the Displayer Window part (121).

The rear-view monitoring Master Device (100) in the invention receives the input YUV (the luminance component Y and the chrominance components Cb and Cr) image signal from an indoor Camera (152) that is made up of CMOS (NMOS, CCD) image sensor in various sizes (e.g., 320×240, 640×480 D1 grade), input speed (e.g., 30 frames/second) and formats (e.g., 4:2:2). It then converts the input into a compressed form (e.g., 4:2:0) in the Video Codec part (50), using a standard video compression method (e.g., H.264, MPEG-1 & 2, MPEG-4, H.263, H.264, Wavelet, JPEG). The compressed signal is assembled into packet data to be transmitted via Robust Wireless Transceiver part using a multi-media transmission protocol (TCP/IP, UDP/IP, RTP, RTCP) in short-distance wireless environment (e.g., Wi-bro, wirelessLAN), or stored in the Memory part (40; Flash memory, HDD).

The wireless multi-media streaming service of the invention is for the real-time transmission of video and audio data in short-distance wireless environment. Thus it is desirable to use protocols such as Real Time Transport Protocol (RTP) and Real Time Control Protocol (RTCP): for real-time transmission the compressed data in RTP packet will be packetised and the received RTP packet will be analysed by video/image Codec to be unpacketised and to be displayed in the Displayer part (90).

The digital images captured by the Indoor Camera (152) or the Slave Device (200) of the rear-view monitoring system will be compressed by a standard video compression technology (e.g., H.264 method). The compressed video data bypass the CPU in the Data Processor/Control CPU part (30) using the DMA device (figure not presented), and get transferred directly to a SDRAM memory (figure not presented). The image thus can be directly brought to the Memory part (40) in real-time. The CPU will be asked to interrupt for each frame of entering image. The interrupt service routine activates the DMA device to store several frames of image.

In hardware, it is desirable for the Audio and Video Codec (50, 60) to be in a onechip format or built in a DSP chip to ensure high compression rate and good quality of data and to minimize the delay time between the transmitting and receiving ends. In addition, it is advised to use a software codec (e.g., TCM by Thin Multimedia and H.264 by Ingenient) to reduce the load of the CPU and power usage.

There are several video and audio codec methods. There are MPEG-4, MPEG-2, H.263, H.264, Wavelet etc. for video, and ADPCM (G.726), G.723.1, AAC, MP3, AAC, WMA etc. for audio.

In choosing an Audio (voice) Codec (60), the G.726 (ADPCM) method has the merit of simple processing that does not affect the video compression while, being the ADPCM method, its data size is rather big. When video and audio data are simultaneously transferred, it is generally considered that the continuity of audio data (the minimization of the delay time) is more important than that of video data.

When video and audio data are transferred to the network using the same port, the video data that has relatively large data size would affect the transmission of the audio data. Therefore the discontinuity of the audio data can be minimised by assigning separate ports to video and audio data.

For the Audio (voice) Codec (60) in the invention, the AAC audio, with an efficiency 30-50% better than MP3, or the G.723.1 or ADPCM is used. For the video decompression Codec, it is desirable to use MPEG-4 or H.264 Codec which has a good compression rate and image quality.

Generally the bandwidth used for transmission of voice or audio data is 64 Kbps for uncompressed PCM, 13 Kbps for QCELP, 8 Kbps for G.726 (CS-ACELP), 4.8 Kbps for G.723.1 (5.6 Kbps for VoIP), 352.8 Kbps for audio data and 128 Kbps for MP3 streaming audio.

The bandwidth required for video transmission is 221 Mbps for uncompressed SDTV grade, 1.3 Gbps for uncompressed HDTV, 4-8 Mbps for compressed SDTV (MPEG-2), 19.4 Mbps for compressed HDTV (MPEG-2), 1.5 Mbps for MPEG-1 and 1 Mbps for compressed SDTV grade H.264.

The Memory part (40) can use a Flash memory, SDRAM memory or a small-size HDD (e.g., <1.8 inch by TOSHIBA) that can store large-size data. It is desirable for the invention to have the USB2.0 interface for a high-speed transmission of the data stored in the large-size or Flash memory to an external device. In addition, it is desirable to have a rechargeable battery (e.g., lithium or polymer batteries by Samsung SDI, Sanyo or Kokam Engineering).

In the invention, the Indoor Camera (152) acquires information only when a moving object (a perpetraitor or an intruder) appears in the monitoring area, saving the Video Storage Memory (40) and reducing the frequency of data transmission. The moving object is identified as follows: the image difference between the reference image and the currently acquired image defined as a difference image, of which pixels have the absolute values of the difference in corresponding pixels in the two images (No negative values allowed in pixel values for color). A critical value is defined to separate the background from an object. Then an area is designated, and the noise is removed by using the percentage of pixels with white (255) color. The method is explained in the followings.

In an ideal case, the pixels in the difference image would have zero. However, it is seldom the case. It is because of the physical noise produced when the data converted from analogue to digital. It also has to do with the environmental factors such as the illumination or the scattering of light in the monitoring area. The noise due to the image subtraction, unlike that of an moving object that takes up a specific area, mostly appears scattered on the edge of an object in line segments (vertical or horizontal). In a histogram, the difference image would have the maximum at zero and declines as the brightness increase. Such noise would have the pixel value of 255 (white). When two images are taken for the same area and one is subtracted from the other, the difference image does not have zero pixel values, which necessitates the removal of the noise.

To remove the noise from the difference image, the noise pixel will be replaced with the median value of the pixels around it. In a specific area P(x, y) is defined, the percentage of the pixels with white (255) value will be compared with a pre-defined reference ratio. If the white-pixel percentages exceeds the reference rate, the pixels in the specified area P(x, y) (e.g., the pixels in a 5×5 matrix) are set to white (255), and otherwise black (0). Here the reference ratio (%) is the percentage of the pixels with value 255 in the specified area P(x, y), and is calculated as follows:

Reference Rate(%)=(the total number of pixels with value 255/the size of the matrix)×100

Here the size of matrix is related to the accuracy and speed of noise removal. If the size is defined small, then the speed of noise removal is high while the accuracy of data discrimination deteriorates. On the contrary, a big size matrix would increase the accuracy while slowing the speed. Thus it is important to define a matrix with a proper size. As the reference rate increases, the expression of 0 (black) gets stronger, clearly showing the noise removal. However, the data within a moving object can be misidentified as noise.

After the noise removal, the appearance of an moving object will be detected, its boundary will be identified and its movement will be traced. For the four sides of the acquired image, the number of pixels will be increased/decreased in X- and Y-axis and the pixels with value 255 are searched for. If there is no pixel with value 255, it means no moving object in the frame. In the meanwhile, if there is pixels with value 255, it means there is a moving object in the frame along that side. Thus its boundary needs to be identified. In other words, when the pixel value 255 is detected, the coordinates of the pixel is stored and the increase/decrease will be stopped immediately. When the above process is performed for all four sides, the coordinates of the identified pixels will become the boundary pixels of the moving object. The largest coordinate values on each side will be taken as the area data and will be used in tracking the move of the object. The edge of the moving object can be altered with a subtle change of the boundary, and thus cannot be used in tracking the moving object. Instead the center of the object will be used in tracking its move. The coordinates (Ci) of the center of the moving object center can be calculated as follows:

Ci,x=(right−left)/2+left

Ci,y=(bottom−top)/2+top

where i=0, 1, 2, . . . , n−1 and n is the number of a series of frames in which the moving object were detected.

So far the figures and specifications of optimal applications are presented. Specific terms used here are only to help explaining the invention, rather than to limit the meaning or the scope of the invention in requesting patents. Anyone who is familiar with in this field would understand that various modifications and equally convincing applications are possible. Therefore, the extent of protection needed for the invention with a patent should be determined by the attached technical idea of the scope of patent request.

### Sequence Listing

Robust wireless communication, master device, slave device, rear view monitoring, for vehicles

1. (canceled)

2. A Master Device (100) for robust modulation wireless communication master device comprising:
a Robust Wireless Transceiver part (10) having a function of robust wireless modulation communication;
a TDMA RF (Time Division Multiple Access Radio Frequency) Transceiver part (20) that, connected to the Robust Wireless Transceiver part (10), transmits and receives data,
a processor/control CPU part (30) that is connected to the Robust Wireless Transceiver part (10) and that has the control function;
a Memory part (40) that is connected to the processor/control CPU part (30) and stores operation related data;
a video Codec part (50) that is connected to the processor/control CPU part (30) and the Memory part (40);
an audio Codec part (60) that is connected to the Memory part (40);
an input/output interface for external signals (70) that is connected to the video Codec part (50) and the audio Codec part (60);
a Recharging Circuit part (80) that is connected to the processor/control CPU part (30);
a Displayer part (90) that is connected to the processor/control CPU part (30) and the Memory part (40).

3. The Master Device (100) for robust modulation wireless communication as set forth in claim 2, further comprising:
an Image Enhancement Processor (16) that is connected to the processor/control CPU part (30) and the video Codec part (50);
an Image Sensing part (17) that is connected to the Image Enhancement Processor (16); and
a Selective Function Optical Lens part (18) connected to the Image Enhancement Processor.

4. The Master Device (100) for robust modulation wireless communication as set forth in claim 3, wherein
the Image Enhancement Processor (16) is in the form of an Indoor Camera (152).

5. A Master Device of a rear view monitoring system for vehicles (100) using a robust wireless communication device (RWCD), comprising:
a Robust Wireless Transceiver part (10) that has the function of robust wireless modulation communication;
a TDMA RF (Time Division Multiple Access Radio Frequency) Transceiver part (20) that is connected to the Robust Wireless Transceiver part (10) and that performs data transmission and reception;
a processor/control CPU part (30) that is connected to the Robust Wireless Transceiver part (10), and that has the function of data control;
a Memory part (40) that is connected to the processor/control CPU part (30), and that stores operational data;
a video Codec part (50) that is connected to processor/control CPU part (30) and to the Memory part (40);
a audio Codec part (60) that is connected to the Memory part (40);
a input/output interface for external signals (70) that is connected to the video Codec part (50) and the audio Codec part (60);
a Recharging Circuit part (80) that is connected to the processor/control CPU part (30);
a Mainbody of Displayer (110) that contains inside the Robust Wireless Transceiver part (10), the TDMA RF (Time Division Multiple Access Radio Frequency) Transceiver part (20), the Memory part (40), the video Codec part (50), the audio Codec part (60), the input/output interface for external signals (70) and the Recharging Circuit part (80);
a Rotating Displayer part (120) that is attached to a side or the bottom of the Mainbody of Displayer (110) with Rotating Contact part (150) and Rotating Axis (151);
a Displayer Window part (121) that is installed on the frontside of the Rotating Displayer part (120);
a Sliding Clip Holder (140) that are installed on both sides of the Mainbody of Displayer (110); and
a keypad (170) that is used to have the input data for operation keyed in input.

6. The RWCD-using Master Device of a rear view monitoring system for vehicles (100) as set forth in claim 5 further comprising:
an Image Enhancement Processor (16) that is connected to the processor/control CPU part (30) and the video Codec part (50);
an Image Sensing part (17) that is connected to the Image Enhancement Processor (16);
a Selective Function Optical Lens part (18) that is connected to the Image Enhancement Processor (16).

7. The RWCD-using Master Device of a rear view monitoring system for vehicles (100) as set forth in claim 6, wherein
the Image Enhancement Processor (16) is in the form of an Indoor Camera (152).

8. The RWCD-using Master Device of a rear view monitoring system for vehicles (100) as set forth in claim 5 further comprising:
a Portable Device/Joint part (600) that replaces the Rotating Displayer part (120) and that is connected with the Rotating Contact part (150) and the Rotating Axis (151);
a Connector-Locking Device (605) that is connected to the Portable Device Contact/Joint part (600);
a Connector (601) that is installed on the Portable Device Contact/Joint part (600);
a Portable Device (604) that is inserted into the Portable Device Contact/Joint part (600);
a Connector for External Interface (602) that is installed on the Portable Device (604) and inserted into the connector (601).

9. The RWCD-using Master Device of a rear view monitoring system for vehicles (100) as set forth in claim 5 further comprising:
a Screw Hole (143) formed on top of a Sliding Clip Holder (140);
a Screw (142) connected to the Screw Hole (143).

10. The RWCD-using Master Device of a rear view monitoring system for vehicles (100) as set forth in claim 5 further comprising:
a solar battery (160) connected to the Recharging Circuit part (80) and installed on the rear side of the Mainbody of Displayer (110).

11. The RWCD-using Master Device of a rear view monitoring system for vehicles (100) as set forth in claim 10 further comprising:
an auxiliary solar battery (161) connected to the Recharging Circuit part (80) and installed on the front mirror or dashboard of a vehicle.

12. A RWCD-using Master Device (100) of a rear view monitoring system for vehicles comprising:
a Robust Wireless Transceiver part (10) that performs the robust modulation wireless communication;
a TDMA RF (Time Division Multiple Access Radio Frequency) Transceiver part (20) that is connected to the Robust Wireless Transceiver part (10) and that performs data transmission and reception;
a processor/control CPU part (30) that is connected to the Robust Wireless Transceiver part (10), and that has the function of data control;
a Memory part (40) that is connected to the processor/control CPU part (30), and that stores operational data;
a video Codec part (50) that is connected to processor/control CPU part (30) and to the Memory part (40);
an audio Codec part (60) that is connected to the Memory part (40);
an Interface part for External Signal Input/Output (70) that is connected to the video Codec part (50) and the audio Codec part (60);
a Recharging Circuit part (80) that is connected to the processor/control CPU part (30);
a Mainbody of Displayer (110) that contains a built-in Robust Wireless Transceiver part (10), the TDMA RF (Time Division Multiple Access Radio Frequency) Transceiver part (20), the Memory part (40), the video Codec part (50), the audio Codec part (60), the input/output interface for external signals (70) and the Recharging Circuit part (80), and that can be installed on the front mirror or dashboard of a vehicle with double-stick adhesive;
a Rotating Displayer part (120) that is connected to a side or the bottom of the Mainbody of Displayer (110) by a Rotating Joint part (150) and a Rotational Axis (151);
a Displayer Window part (121) that is installed on the front of the Rotating Displayer part (120);
a keypad (170) that is used to have the input data for operation keyed in input.

13. The RWCD-using Master Device of a rear view monitoring system for vehicles (100) as set forth in claim 12 further comprising:
a detachable auxiliary solar battery (161) connected to the Recharging Circuit part (80) and installed on the front mirror or dashboard of a vehicle.

14. A RWCD-using Slave Device of a rear view monitoring system for vehicles comprising:
a Selective Function Optical Lens part (210) that automatically selects auto focus (AF) and Pan/Tilt/Optical zoom;
an Image Sensing part (220) that senses images from the Selective Function Optical Lens part (210);
an Image Enhancement Processor (230) that removes noise in the signal from the Image Sensing part (220) to provide a high quality images even in low or illumination;
a video Codec part (240) that is connected to the Image Enhancement Processor (230);
a processor/control CPU part (250) that is connected to the Image Enhancement Processor (230) and the video Codec part (240);
a Memory part (260) that is connected to the processor/control CPU part (250) and the video Codec part (240);
a Robust Wireless Transceiver part (270) that is connected to the processor/control CPU part (250) and has the function of robust wireless communication;
a TDMA RF (Time Division Multiple Access Radio Frequency) Transceiver part (280) that is connected to the Robust Wireless Transceiver part (270);
a reversing light sensing circuit part (290) that is connected to the processor/control CPU part (250);
a brake light sensing circuit part (291) that is connected to the processor/control CPU part (250);
a main body of the slave device of the rear view monitoring (201) that has the Selective Function Optical Lens part (210) installed on the front and built-in Selective Function Optical Lens part (210), the Image Sensing part (220), the Image Enhancement Processor (230), the video Codec part (240), the processor/control CPU part (250), the Memory part (260), the Robust Wireless Transceiver part (270), the TDMA RF Transceiver part (280), the reversing light sensing circuit part (290) and the brake light sensing circuit part (291).

15. The RWCD-using slave device of a rear view monitoring system for vehicles as set forth in claim 14 further comprising:
a flash lamp (293) that is installed on the front of the main body of the slave device (201) and operates when shooting a rear view in the dark.

16. The RWCD-using Slave Device of a rear view monitoring system for vehicles as set forth in claim 15 further comprising:
a tail lights (292) that are installed on the main body of the slave device (201) and operates inter-locked with reversing or braking.

17. The RWCD-using Slave Device of a rear view monitoring system for vehicles as set forth in claim 16 further comprising:
a Rear-view Camera/Casing Device (200) to which the Image Sensing part (220), the Flash Lamp (293) and the Tail Light (292) are attached, and that, being in the shape of an emblem of a vehicle, can be attached to the location of the emblem.

18. The RWCD-using Master Device of a rear view monitoring system for vehicles (100) as set forth in claim 5 further comprising:
a Contact/Joint part (910) that is attached to the bottom front of the Mainbody of Displayer (110), and that can, being in the same shape can, replace the battery of a Portable Device (604) for recharging.

19. The RWCD-using Master Device of a rear view monitoring system for vehicles (100) as set forth in claim 5 further comprising:
a Cradle-type Contact/Joint part (911) that is attached to the bottom front of the Mainbody of Displayer (110), and has a shape that corresponds to each Portable Device (604), with its front open in order to have the display window of the Portable Device and keys exposed;
the Portable Device (604) that is connected to the Cradle-type Contact/Joint part (911);
a Connector for External Interface (602) that is installed in the Portable Device (604);
a connector (601) that is connected to the Mainbody of Displayer (110) via connecting cables (904) and to the Connector for External Interface (602).

20. The RWCD-using Master Device of a rear view monitoring system for vehicles (100) as set forth in claim 19 further comprising:
a Microphone (905) and a Speaker (906) that is attached to the Mainbody of Displayer (110) to enable hands-free operation.

21. The RWCD-using Master Device of a rear view monitoring system for vehicles (100) as set forth tin claim 20 further comprising:
a groove part (955) that is shaped for Screen of a Portable Device (603) in order to move smoothly without being contacted or blocked by the Cradle-type Contact/Joint part_(911).

22. The RWCD-using Master Device of a rear view monitoring system for vehicles (100) as set forth in claim 19 further comprising:
an external antenna port for GPS (957) that is installed on a side of the Mainbody of Displayer_(110) and into which the external antenna for GPS can be inserted;
a memory card slot (956) that is installed on a side of the Mainbody of Displayer (110) and into which a memory card with navigation maps and software or general data can be inserted.

23. A Robust Wireless Transceiver part (10) that has the function of robust modulation wireless communication;
a TDMA RF (Time Division Multiple Access Radio Frequency) Transceiver part (20) that is connected to the Robust Wireless Transceiver part (10) and communicates the data;
a processor/control CPU part (30) that is connected to the Robust Wireless Transceiver part (10), and has the function of control;
a Memory part (40) that is connected to the processor/control CPU part (30), and stores operational data;
a robust modulation wireless communication Master Device (100) that consists of the above parts, and that, when needed, can include one or more of the following parts: a video Codec part (50), an audio Codec part (60), an input/output interface for external signals (70), an Displayer part (90) or an Recharging Circuit part (80).

24. A robust wireless communication method comprising the steps of:
searching a modulation-demodulation (M-D) methods for selection among arbitrary basebands in the frequency band to be used (Step 1);
setting up minimum BER (Bit Error Rate) for each datum in order to find out the optimal BER (Bit Error Rate) among the selected baseband modulation-demodulation (M-D) methods in Step 1 during transmitting simple or multi-media data (Step 2);
creating a channel using a Baseband modulation-demodulation (M-D) method, while the minimum BER (Bit Error Rate) is measured for each created channel for different data types to test the efficiency of the channel (Step 3);
testing the selected Baseband modulation-demodulation (M-D) method in order to see if it could create a transmission channel within the defined minimum BER (Bit Error Rate) range (Step 4);
repeating the steps 1-4 with a new Baseband modulation-demodulation (M-D) method if the tested method in Step 4 is proved to be unsuitable (Step 5);
using the best among the selected Baseband modulation-demodulation (M-D) methods during data transmission if the tested method of Step 4 is proved that the method is suitable (Step 6);.
modulating the data using a method that includes OOK (On/Off Keying) modulation, and transmitting the data using a UHF band (Step 7);
transmitting the data wirelessly (Step 8);
performing non-OOK modulation for non-UHF simple data or video data (Step 11) or audio data (Step 13) before being transmitted, wherein the multimedia data gets to reduce the size using appropriate formats before going through the modulation process.

25. The robust wireless communication method according to claim 24, wherein the method uses one out of ISM/UHF weak wave/unlicensed small power frequency band in Step 1.

26. The robust wireless communication method according to claim 24 wherein Step 1 uses the maximum power output of 100 mW (20 dBm), and wherein either TDMA RF method or wireless Koinonia method is used for an arbitrary Baseband modulation-demodulation (M-D) method.

27. The robust wireless communication method according to claim 24, wherein the range of BER (Bit Error Rate) defined in Step 2 depends on data type, wherein the minimum BER range is less than ←10⁻⁵ for H.264 video data, less than ←10⁻³˜10⁻⁴ for ADPCM audio data, and less than ←10⁻⁸˜10⁻¹⁰ for simple data.

28. The RWCD-using Master Device of a rear view monitoring system for vehicles as set forth in claim 12, wherein Mainbody of Displayer (110) includes Robust Wireless Transceiver part (10), TDMA RF Transceiver part (20), processor/control CPU part (30) and Memory part (40), wherein one or more amongst the video Codec part (50), audio Codec part (60), input/output interface for external signals (70) or Recharging Circuit part (80) can be added.

29. A RWCD-using Slave Device of a rear view monitoring system for vehicles that features a processor/control CPU part (250), a Memory part (260), a Robust Wireless Transceiver part (270) and a TDMA RF (Time Division Multiple Access Radio Frequency) Transceiver part (280) as basic components, wherein one or more amongst a Selective Function Optical Lens part (210), an Image Sensing part (220), an Image Enhancement Processor (230), a video Codec part (240), a reversing light sensing circuit part (290) or a brake light sensing circuit part (291) can be added.
